(19) United States
(12) Patent Application Publication
(10) Pub. No.: US 2012/0250077 A1
(43) Pub. Date: Oct. 4, 2012

(54) INFORMATION PROCESSING APPARATUS, COMPUTER READABLE MEDIUM STORING PROGRAM FOR PERFORMING PROCESSING, AND INFORMATION PROCESSING METHOD

(75) Inventors: Ryouhei IWASAKI, Saitama (JP); Osamu MURAKAMI, Kanagawa (JP)

(73) Assignee: FUJI XEROX CO., LTD., TOKYO (JP)

(21) Appl. No.: 13/184,183

(22) Filed: Jul. 15, 2011

(30) Foreign Application Priority Data
Mar. 28, 2011 (JP) 2011-070425

(51) Int. Cl. G06F 3/12

(52) U.S. Cl. 358/1.15

(57) ABSTRACT

An information processing apparatus includes a receiving unit, a storage unit, at least one rasterization processing unit, a saving unit, a calculation unit, a determination unit, and a notification unit. The receiving unit receives print information described in a page description language. The storage unit stores the received print information. The rasterization processing unit executes a rasterization process. The saving unit saves, as cache data, bitmap data generated using the rasterization process for each object included in the print information. The calculation unit analyzes the print information to detect an object to be saved as cache data, and calculates an amount of cache data of the object before the rasterization process is executed. The determination unit totals a calculated amount of cache data, and determines whether or not the total amount has reached a predetermined limit value. The notification unit gives a notification of an obtained determination result.

### CROSS-REFERENCE TO RELATED APPLICATIONS

This application is based on and claims priority under 35 USC 119 from Japanese Patent Application No. 2011-070425 filed Mar. 28, 2011.

### BACKGROUND

(i) Technical Field

The present invention relates to an information processing apparatus, a computer readable medium storing a program for performing processing, and an information processing method.

(ii) Related Art

Printer controllers serving as information processing apparatuses incorporated in high-speed printers generally perform a “rasterization” process for converting page description language data (print information) described in a page description language into bitmap data.

Cache technology has been available as a technology for speeding up the rasterization process.

Cache technology is a technology of storing in a cache memory rasterized bitmap data or the like of various objects (such as overlays, fonts, and images) included in page description language data and calling each of the objects via the cache memory in the subsequent and following processing operations to increase the speed of the overall processing.

### SUMMARY

According to an aspect of the invention, there is provided an information processing apparatus including a receiving unit, a storage unit, at least one rasterization processing unit, a saving unit, a calculation unit, a determination unit, and a notification unit. The receiving unit receives print information described in a page description language. The storage unit stores the print information received by the receiving unit. The rasterization processing unit executes a rasterization process for converting the print information into bitmap data. The saving unit saves, as cache data, bitmap data generated using the rasterization process for each object included in the print information. The calculation unit analyzes the print information to detect an object to be saved as cache data, and calculates an amount of cache data of the object before the rasterization processing unit executes the rasterization process. The determination unit totals an amount of cache data calculated by the calculation unit, and determines whether or not the total amount has reached a predetermined limit value. The notification unit gives a notification of a determination result obtained by the determination unit.

### BRIEF DESCRIPTION OF THE DRAWINGS

Exemplary embodiment(s) of the present invention will be described in detail based on the following figures, wherein:

FIG. 1 is a functional block diagram illustrating the functional configuration of an information processing apparatus according to an exemplary embodiment;

FIG. 2 illustrates an example of an overlay on a page;

FIG. 3 is a block diagram illustrating an example configuration of an information processing apparatus according to a first example;

FIG. 4 is a flowchart illustrating a processing procedure of a printing process;

FIG. 5 is a flowchart illustrating the continued operation of the processing procedure of the printing process;

FIG. 6 is a flowchart illustrating the continued operation of the processing procedure of the printing process;

FIG. 7 is a table illustrating an example configuration of an overlay table;

FIG. 8 is a block diagram illustrating an example configuration of an information processing apparatus according to a second example;

FIG. 9 is a flowchart illustrating a processing procedure of a printing process;

FIG. 10 is a flowchart illustrating the continued operation of the processing procedure of the printing process; and

FIG. 11 is a flowchart illustrating the continued operation of the processing procedure of the printing process.

### DETAILED DESCRIPTION

An exemplary embodiment of the present invention will be described in detail with reference to the drawings. In the drawings, the same members or substantially the same members are assigned the same numerals, and will not be described redundantly. An exemplary embodiment of the present invention described herein is merely illustrative, and the present invention is not intended to be limited to the following exemplary embodiment.

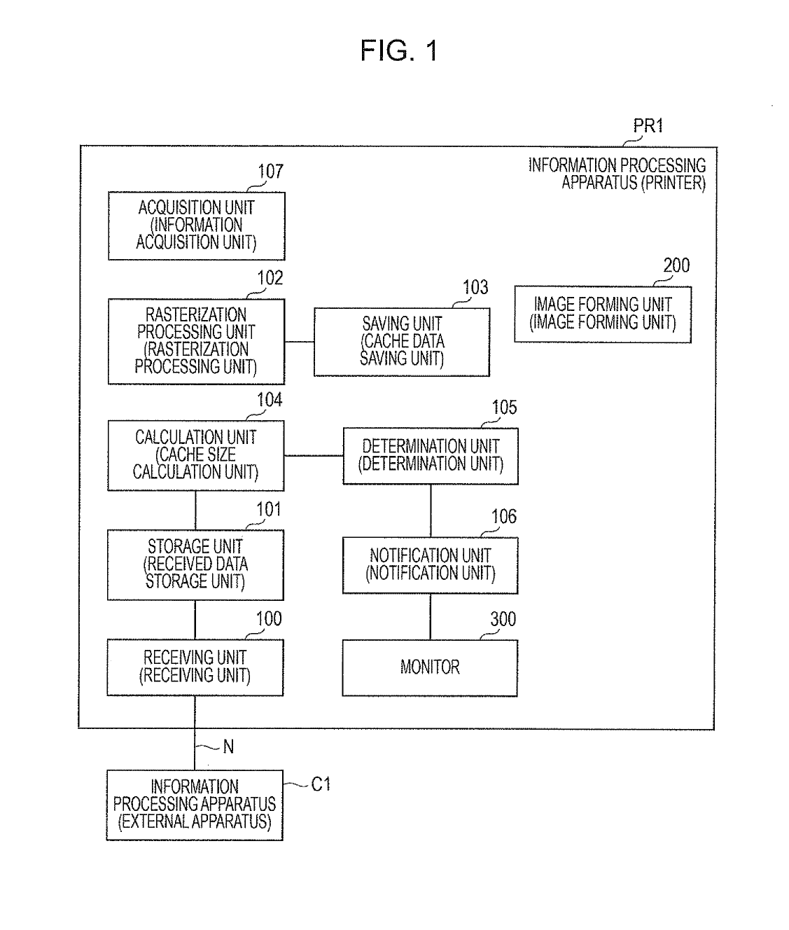

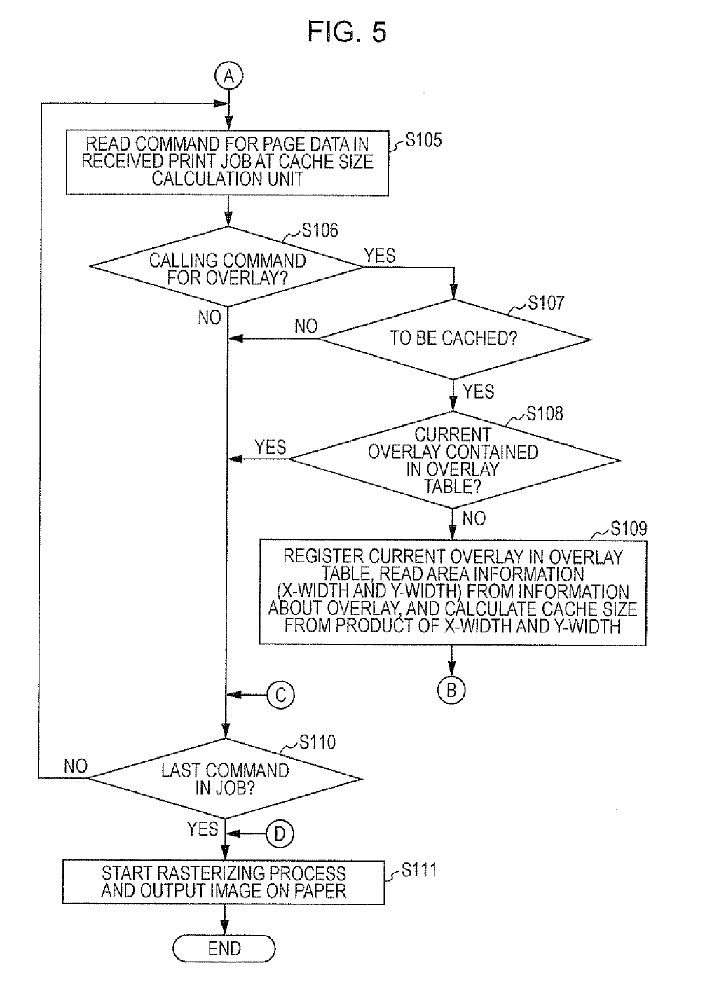

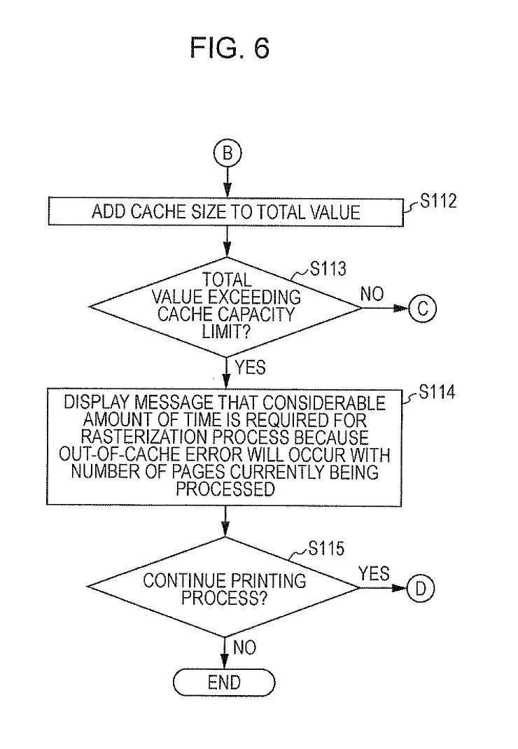

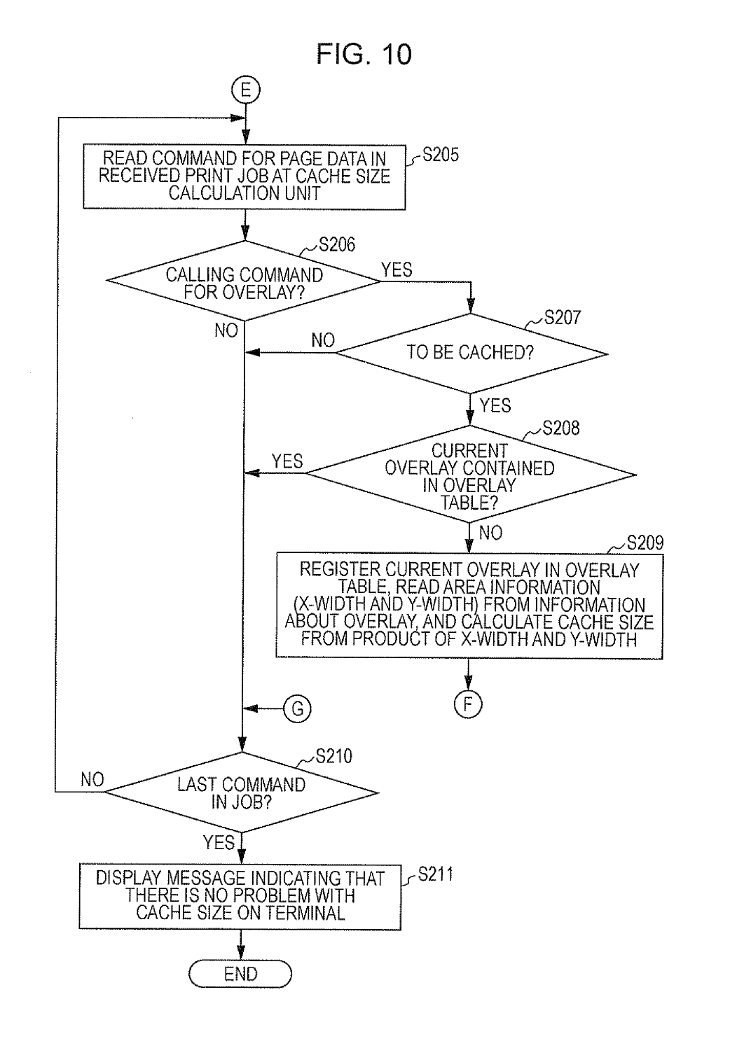

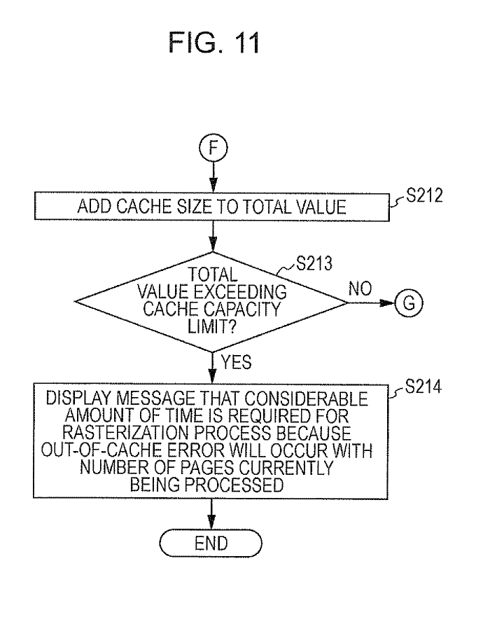

An information processing apparatus PR1 according to an exemplary embodiment of the present invention will be described with reference to FIGS. 1 to 11.

First, the functional configuration of the information processing apparatus PR1 will be described with reference to FIG. 1.

The information processing apparatus PR1 according to this exemplary embodiment may be a high-speed printer or the like, and receives, from an information processing apparatus (external apparatus) C1 such as a host computer, page description language print information generated by the information processing apparatus C1 via a network N such as a local area network (LAN). The information processing apparatus PR1 then forms an image on a recording medium such as a paper roll.

The information processing apparatus PR1 includes a receiving unit 100 (an example of a receiving unit), a received data storage unit 101 (an example of a storage unit), a rasterization processing unit 102 (an example of a rasterization processing unit), a cache data saving unit 103 (an example of a saving unit), a cache size calculation unit 104 (an example of a calculation unit), a determination unit 105 (an example of a determination unit), and a notification unit 106 (an example of a notification unit).

The receiving unit 100 receives print information (print data) described in a page description language. The received data storage unit 101 stores the print data received by the receiving unit 100. The rasterization processing unit 102 executes a rasterization process for converting the print data into bitmap data. The cache data saving unit 103 may be formed of a cache memory configured to save, as cache data, bitmap data generated using a rasterization process for each of objects included in the print data. Before the rasterization processing unit 102 executes a rasterization process, the cache size calculation unit 104 analyzes the print data to detect objects to be saved as cache data, and calculates the amounts of the cache data of the objects. The determination unit 105 totals the respective amounts of the cache data calculated by the cache size calculation unit 104, and determines whether or not the total amount has reached a predetermined limit value. The notification unit 106 gives a notification by displaying the determination result of the determination unit 105 on a monitor 300 such as a touch panel.

The information processing apparatus PR1 further includes an information acquisition unit 107 (an example of a acquisition unit) that acquires information regarding the rasterization processing unit 102.

The determination unit 105 may determine whether or not the total amount has reached the limit value by taking into account the information regarding the rasterization processing unit 102 acquired by the information acquisition unit 107.

Examples of the information regarding the rasterization processing unit 102 may include at least one of the number of rasterization processing units 102, the cache capacity limit of the cache data saving unit 103 that is provided in each rasterization processing unit 102, and information regarding whether or not a distribution process is required.

The determination unit 105 may also total the amounts of cache data of objects to be saved as cache data when printing starts, and calculate number-of-pages information about the number of pages that exceed the total amount or about the preceding page up to which an out-of-cache error does not occur. Then, the notification unit 106 may notify a user that an out-of-cache error will occur and also notify the user of the number-of-pages information.

If the determination unit 105 determines that the sum of the amounts of cache data of the objects to be saved as cache data when printing starts does not exceed the cache capacity limit of the cache data saving unit 103 provided in each rasterization processing unit 102, the rasterization processing unit 102 may start a rasterization process. If the determination unit 105 determines that the sum exceeds the cache capacity limit, the rasterization processing unit 102 may not execute a rasterization process.

If a distribution process is required over rasterization processing units 102, the above determination may be based on the assumption that one rasterization processing unit 102 performs a rasterization process on all the pieces of page description language data.

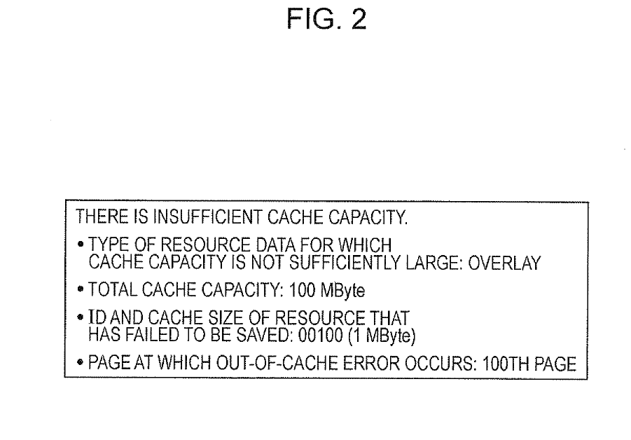

FIG. 2 illustrates an example of a notification given by the information processing apparatus PR1 according to this exemplary embodiment.

In the notification illustrated in FIG. 2, the message “There is insufficient cache capacity” is, followed by information such as the type of object data (for example, an overlay) for which the cache capacity is not sufficiently large, the total cache capacity (for example, 100 megabytes (MB)), the ID and cache size of an object that has failed to be saved (for example, “00100” and 1 MB), and the page at which an out-of-cache error occurs (for example, the 100th page) is displayed.

The user or other person who has received the notification takes measures to reduce the number of pages of print data or to modify the print data to reduce the cache size. Therefore, printing efficiency may be improved.

### First Example

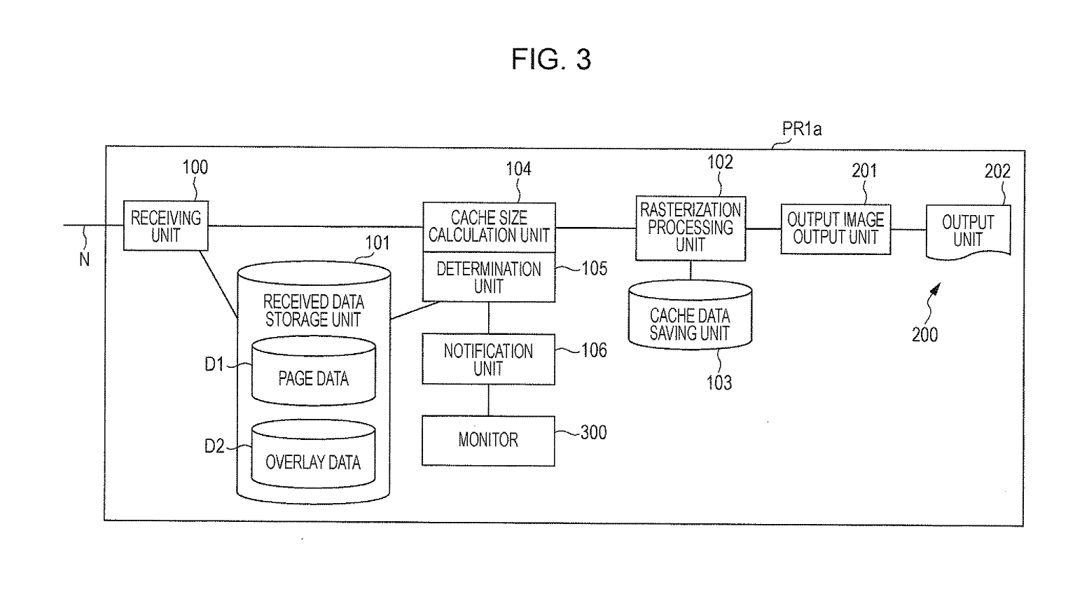

Next, a first example of the present invention will be described with reference to FIGS. 3 to 9.

An information processing apparatus PR1a according to the first example has the configuration as illustrated in the block diagram of FIG. 1.

In FIG. 3, the received data storage unit 101, such as a hard disk device, stores page data D1, overlay data D2, and any other suitable data.

The image forming unit 200 includes an output image output unit 201 and an output unit 202.

The operation of the components illustrated in FIG. 3 will be described.

The receiving unit 100 receives print data, and, while receiving print data, separates the received data into object data such as page data and overlay data to save the page data and the overlay data.

The cache size calculation unit 104 searches the page data for the calling command for an overlay. If the calling command for an overlay is found, the cache size calculation unit 104 checks whether or not cache is available for the overlay.

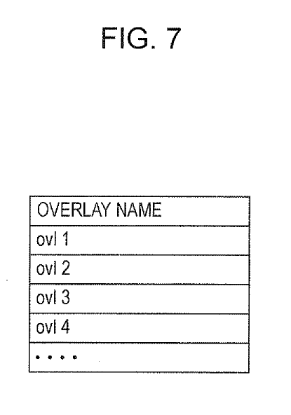

If cache is available, the cache size calculation unit 104 checks whether or not the overlay is contained in an overlay table (see FIG. 7).

If the overlay is contained in the overlay table, the cache size calculation unit 104 ends the process for the current overlay, and searches for the calling command for the next overlay. If the overlay is not contained in the overlay table, the cache size calculation unit 104 registers the overlay in the overlay table, and calculates the number of pixels in the overlay area from information about the x-direction and y-direction widths of the overlay to determine a value indicating the number of pixels as a cache size (cache capacity).

The determination unit 105 adds the cache size to the total cache size of the previous overlays, and determines whether or not the total cache size exceeds the cache limit.

If the total cache size does not exceed the cache limit, the cache size calculation unit 104 ends the process for the current overlay, and searches for the calling command for the next overlay.

If it is determined that the total cache size exceeds the cache limit, the notification unit 106 displays on the monitor 300, such as a touch panel, the number of pages obtained at the current time and a message indicating that too large a cache size will cause an out-of-cache error and therefore the rasterization process will be delayed. The notification unit 106 may also display an option for allowing the user to select to continue or stop the processing on the monitor 300.

Therefore, the user determines whether the user is to continue or stop the printing process and operates the touch panel, which may lead to improvement in user friendliness.

If the total cache size up to the last page does not exceed the cache limit or if the user selects to continue the printing process, a rasterization process and a printing process are started.

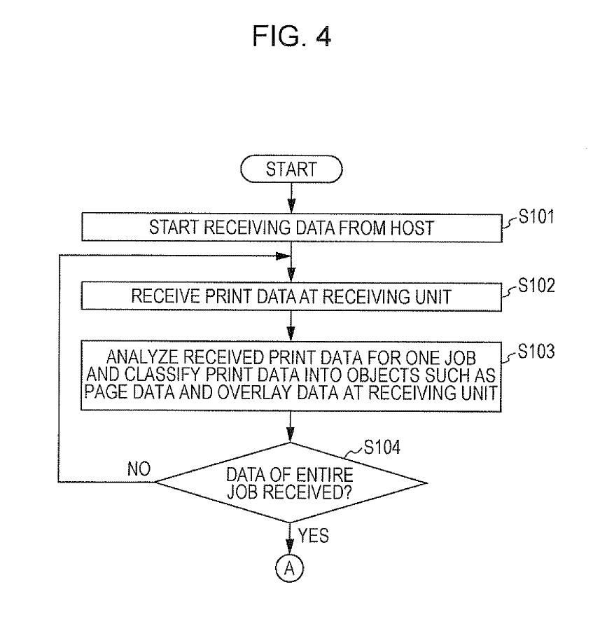

Next, a processing procedure of a printing process executed by the information processing apparatus PR1a according to this example will be described with reference to a flowchart in FIGS. 4 to 6.

In step S101, the information processing apparatus PR1a starts receiving print data from the host computer C1. In step S102, the receiving unit 100 receives print data. Then, the process proceeds to step S103.

In step S103, the receiving unit 100 analyzes received print data for one job, and separates the print data into objects such as page data and overlay data. Then, the process proceeds to step S104.

In step S104, it is determined whether or not data of the entire job has been received. If “NO” is determined, the process returns to step S102. If “YES” is determined, the process proceeds to step S105.

In step S105, the cache size calculation unit 104 reads a command for the page data in the received print job. Then, the process proceeds to step S106.

In step S106, it is determined whether or not the command is the calling command for an overlay. If “NO” is determined, the process proceeds to step S110. In step S110, it is determined whether or not the command is the last command in the job.

If “NO” is determined, i.e., if the command is not the last command in the job, the process returns to step S105. If “YES” is determined, i.e., if the command is the last command in the job, the process proceeds to step S111. In step S111, a rasterization process is started and an image is output on printing paper. Then, the process ends.

If “YES” is determined in step S106, the process proceeds to step S107. In step S107, it is determined whether or not the overlay is to be cached. If “NO” is determined, the process proceeds to step S110. If “YES” is determined, the process proceeds to step S108.

In step S108, it is determined whether or not the current overlay is contained in the overlay table (see FIG. 7). If “YES” is determined, the process proceeds to step S110. If “NO” is determined, the process proceeds to step S109.

In step S109, the cache size calculation unit 104 registers the overlay in the current overlay table, reads area information (x-width, y-width) from information about the overlay, and calculates the cache size (cache capacity) from the product of the x-width and the y-width. Then, the process proceeds to step S112.

In step S112, the cache size calculation unit 104 adds the cache size to the total value. Then, the process proceeds to step S113.

In step S113, it is determined whether or not the total value exceeds the cache capacity limit of the cache data saving unit 103. If “NO” is determined, the process returns to step S110. If “YES” is determined, the process proceeds to step S114.

In step S114, a message indicating that a considerable amount of time is required for the rasterization process because an out-of-cache error will occur with the number of pages currently being processed is displayed on the monitor 300. Then, the process proceeds to step S115.

In step S115, it is determined based on the user operation whether or not the printing process is to be continued. If “YES” is determined, the process proceeds to step S111. If “NO” is determined, the printing process ends.

Accordingly, before the execution of a printing process, the information processing apparatus PR1a according to this example checks whether or not the rasterization process on print data will cause the cache capacity to be exceeded. Therefore, an undesirable situation may be avoided in which an excessive time is required for the rasterization process because of an out-of-cache error.

### Second Example

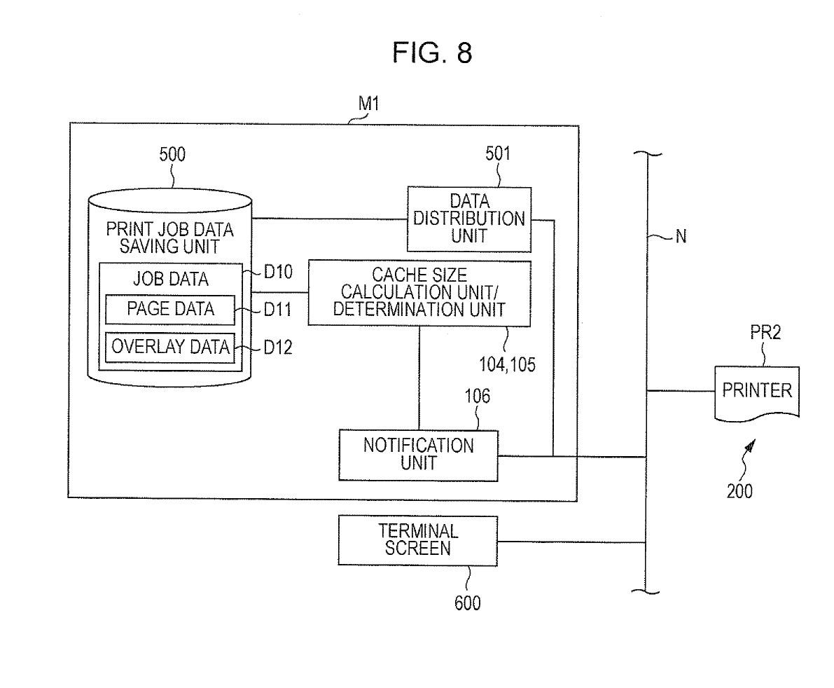

Next, a second example of the present invention will be described with reference to FIGS. 8 to 11.

An information processing apparatus M1 according to the second example has the configuration as illustrated in a block diagram in FIG. 1.

In the example illustrated in FIG. 8, the image forming unit 200 is formed of a printer PR2 connected to the information processing apparatus M1 via a network N.

Further, information output from the notification unit 106 is displayed on a terminal screen 600 connected via the network N.

In FIG. 8, a print job data saving unit 500, such as a hard disk device, saves job data D10 (including page data D11 and overlay data D12). A data distribution unit 501 distributes the job data D10 stored in the print job data saving unit 500 to the printer PR2.

The operation of the components illustrated in FIG. 8 will be described.

The cache size calculation unit 104 and the determination unit 105 search for desired print job data from the print job data saving unit 500.

The information processing apparatus M1 may receive cache setting information from the printer PR2. In this case, the information processing apparatus M1 receives cache setting information from the printer PR2, and acquires information about the cache capacity limit. Alternatively, the information processing apparatus M1 may receive information about the cache capacity limit from a terminal.

The cache size calculation unit 104 searches the page data for the calling command for an overlay. If the calling command for an overlay is found, the cache size calculation unit 104 checks whether or not cache is available for the overlay.

If cache is available, the cache size calculation unit 104 checks whether or not the overlay is contained in an overlay table (see FIG. 7). If the overlay is contained in the overlay table, the cache size calculation unit 104 ends the process for the current overlay, and searches for the calling command for the next overlay.

If the overlay is not contained in the overlay table, the cache size calculation unit 104 registers the overlay in the overlay table, and calculates the number of pixels in the overlay area from information about the x-direction and y-direction widths of the overlay to determine a value indicating the number of pixels as a cache size (cache capacity).

The determination unit 105 adds the cache size to the total cache size of the previous overlays, and determines whether or not the total cache size exceeds the cache limit.

If the total cache size does not exceed the cache limit, the cache size calculation unit 104 ends the process for the current overlay, and searches for the calling command for the next overlay.

If the total cache size exceeds the cache limit, the notification unit 106 displays, on the terminal screen 600, the number of pages obtained at the current time and a message indicating that too large a cache size will cause an out-of-cache error and therefore the rasterization process will be delayed.

If the total cache size up to the last page does not exceed the cache limit, a message indicating that there is no problem with the cache size may be displayed.

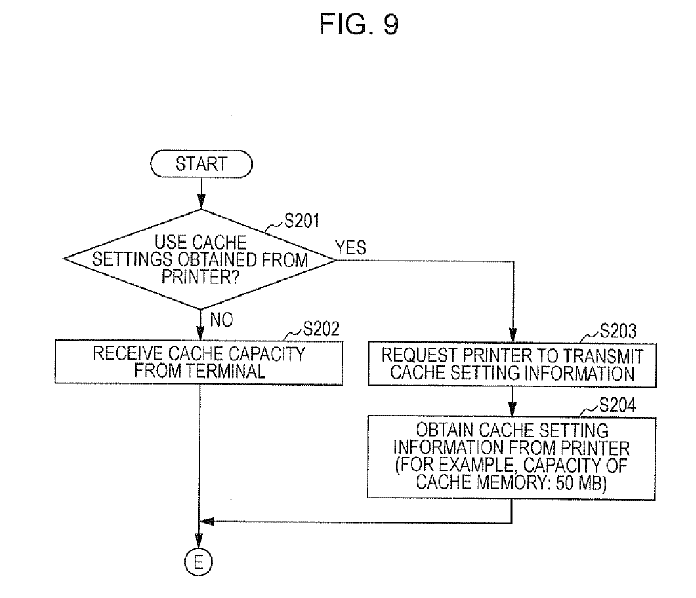

Next, a processing procedure of the printing process executed by the information processing apparatus M1 according to this example will be described with reference to a flowchart in FIGS. 9 to 11.

When this process is started, first, in step S201, it is determined whether or not cache settings obtained from the printer PR2 are to be used. If “NO” is determined, then, in step S202, information about the cache capacity is received from a terminal. Then, the process proceeds to step S205.

If “YES” is determined, the process proceeds to step S203. In step S203, the printer PR2 is requested to transmit cache setting information. Then, the process proceeds to step S204.

In step S204, cache setting information (such as a cache capacity of 50 MB) is acquired from the printer PR2. Then, the process proceeds to step S205.

In step S205, the cache size calculation unit 104 reads a command for the page data in the print job. Then, the process proceeds to step S206.

In step S206, it is determined whether or not the command is the calling command for an overlay. If “NO” is determined, the process proceeds to step S210.

In step S210, it is determined whether or not the command is the last command in the job. If “NO” is determined, i.e., if the command is not the last command in the job, the process proceeds to step S205. If “YES” is determined, i.e., if the command is the last command in the job, the process proceeds to step S211. In step S211, a message indicating that there is no problem with the cache size is displayed on the terminal screen 600. Then, the process ends.

If “YES” is determined in step S206, the process proceeds to step S207. In step S207, it is determined whether or not the overlay is to be cached. If “NO” is determined, the process proceeds to step S210. If “YES” is determined, the process proceeds to step S208.

In step S208, it is determined whether or not the current overlay is contained in the overlay table (see FIG. 7). If “YES” is determined, the process proceeds to step S210. If “NO” is determined, the process proceeds to step S209.

In step S209, the cache size calculation unit 104 registers the overlay in the current overlay table, reads area information (x-width, y-width) from information about the overlay, and calculates the cache size (cache capacity) from the product of the x-width and the y-width. Then, the process proceeds to step S212.

In step S212, the cache size calculation unit 104 adds the cache size to the total value. Then, the process proceeds to step S213.

In step S213, it is determined whether or not the total value exceeds the cache capacity limit. If “NO” is determined, the process proceeds to step S210. If “YES” is determined, the process proceeds to step S214.

In step S214, a message indicating that a considerable amount of time is required for the rasterization process because an out-of-cache error will occur with the number of pages currently being processed is displayed on the terminal screen 600. Then, the process ends.

Accordingly, before the printer PR2 executes a printing process, the information processing apparatus M1 according to this example checks whether or not the rasterization process on print data will cause the cache capacity to be exceeded. Therefore, an undesirable situation may be avoided in which an excessive time is required for the rasterization process because of an out-of-cache error.

While the invention made by the inventors has been described in detail with reference to an exemplary embodiment thereof, it is to be understood that the exemplary embodiment disclosed herein is merely illustrative in any sense and is not intended to be limited to the technology disclosed herein. That is, the technical range of the present invention is not to be construed in a limiting sense based on the foregoing description of the exemplary embodiment, but should be construed in accordance with the appended claims. Any technology equivalent to that described in the appended claims and any changes made to the appended claims may fall within the scope of the invention.

Furthermore, a program may be provided via a network or may be stored in a recording medium such as a compact disc read-only memory (CD-ROM).

A given program including an image processing program may not necessarily be recorded on a storage device such as a hard disk serving as a recording medium, and may also be provided in the following manner.

For example, the given program may be stored in a ROM, and a central processing unit (CPU) may load the given program into a main memory and execute the given program.

The given program may also be stored in a computer-readable recording medium such as a digital versatile disc read-only memory (DVD-ROM), a CD-ROM, magneto-optical disk (MO), or a flexible disk and may be distributed.

An image forming apparatus, or any other similar apparatus, may be connected to a server device or a host computer via a communication line (for example, the Internet), and may download the given program from the server device or the host computer and then execute the given program. In this case, the given program may be downloaded to a memory such as a random access memory (RAM) or to a storage device (recording medium) such as a hard disk.

An information processing apparatus, a computer readable medium storing a program for performing processing, and an information processing method according to exemplary embodiments of the present invention may be used in a printer, a multi-function machine, or any other suitable apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a receiving unit that receives print information described in a page description language;
a storage unit that stores the print information received by the receiving unit;
at least one rasterization processing unit that executes a rasterization process for converting the print information into bitmap data;
a saving unit that saves bitmap data as cache data, the bitmap data being generated using the rasterization process for each object included in the print information;
a calculation unit that analyzes the print information to detect an object to be saved as cache data and calculates an amount of cache data of the object before the rasterization processing unit executes the rasterization process;
a determination unit that totals an amount of cache data calculated by the calculation unit and that determines whether or not the total amount has reached a predetermined limit value; and
a notification unit that gives a notification of a determination result obtained by the determination unit.

2. The information processing apparatus according to claim 1, further comprising an acquisition unit that acquires information regarding the rasterization processing unit,
wherein the determination unit determines whether or not the total amount has reached the limit value by taking into account the information regarding the rasterization processing unit acquired by the acquisition unit.

3. The information processing apparatus according to claim 2, wherein the saving unit is provided in each of the at least one rasterization processing unit, and
wherein the information regarding the rasterization processing unit includes at least one of the number of rasterization processing units, a cache capacity limit of the saving unit provided in each rasterization processing unit, and information regarding whether or not a distribution process is required.

4. The information processing apparatus according to claim 1, wherein the determination unit totals an amount of cache data of an object to be saved as cache data when printing starts, and calculates number-of-pages information indicating the number of pages that exceed the total amount or indicating a preceding page up to which an out-of-cache error does not occur, and
wherein the notification unit gives notification that an out-of-cache error will occur and gives notification of the number-of-pages information.

5. The information processing apparatus according to claim 2, wherein the determination unit totals an amount of cache data of an object to be saved as cache data when printing starts, and calculates number-of-pages information indicating the number of pages that exceed the total amount or indicating a preceding page up to which an out-of-cache error does not occur, and
wherein the notification unit gives notification that an out-of-cache error will occur and gives notification of the number-of-pages information.

6. The information processing apparatus according to claim 1, wherein the saving unit is provided in each of the at least one rasterization processing unit,
wherein the rasterization processing unit starts a rasterization process if the determination unit determines that a sum of an amount of cache data of an object to be saved as cache data when printing starts does not exceed a cache capacity limit of the saving unit provided in the rasterization processing unit, and
wherein the rasterization processing unit does not execute a rasterization process if the determination unit determines that a sum of an amount of cache data of an object to be saved as cache data when printing starts exceeds a cache capacity limit of the saving unit provided in the rasterization processing unit.

7. The information processing apparatus according to claim 2, wherein the saving unit is provided in each of the at least one rasterization processing unit,
wherein the rasterization processing unit starts a rasterization process if the determination unit determines that a sum of an amount of cache data of an object to be saved as cache data when printing starts does not exceed a cache capacity limit of the saving unit provided in the rasterization processing unit, and
wherein the rasterization processing unit does not execute a rasterization process if the determination unit determines that a sum of an amount of cache data of an object to be saved as cache data when printing starts exceeds a cache capacity limit of the saving unit provided in the rasterization processing unit.

8. A computer readable medium storing a program causing a computer to execute a process for performing processing, the process comprising:
receiving print information described in a page description language;
storing the received print information;
executing a rasterization process for converting the print information into bitmap data;
saving bitmap data as cache data, the bitmap data being generated using the rasterization process for each object included in the print information;
before executing the rasterization process, analyzing the print information to detect an object to be saved as cache data and calculating an amount of cache data of the object;
totaling a calculated amount of cache data, and determining whether or not the total amount has reached a predetermined limit value; and
giving a notification of an obtained determination result.

9. An information processing method comprising:
receiving print information described in a page description language;
storing the received print information;
executing a rasterization process for converting the print information into bitmap data;
saving bitmap data as cache data, the bitmap data being generated using the rasterization process for each object included in the print information;
before executing the rasterization process, analyzing the print information to detect an object to be saved as cache data and calculating an amount of cache data of the object;
totaling a calculated amount of cache data, and determining whether or not the total amount has reached a predetermined limit value; and
giving a notification of an obtained determination result.
